(19) United States
(12) Patent Application Publication
(10) Pub. No.: US 2006/0071547 A1
(43) Pub. Date: Apr. 6, 2006

(54) Valve assembly for anti-skid aircraft brakes

(75) Inventor: Robert Edward Holder, Los Angeles, CA (US)

Correspondence Address: Marvin Union;Eaton Corporation, Eaton Center, 1111 Superior Ave., Cleveland, OH, 44114-2584, US

(73) Assignee: Eaton Corporation, Cleveland, OH (US)

(21) Appl. No.: 10/954,910

(22) Filed: Sep. 30, 2004

(51) Int. Cl. B60T 13/74

(52) U.S. Cl. 303/117.1; 303/3; 303/15

(57) ABSTRACT

A hydraulic valve includes a body with bore, a supply port coupled to a first chamber, and a return port connected to the bore and the control chamber. A brake port enables the wheel brake to be connected to the bore, while a brake actuator passage enables pressurized fluid to be introduced into the bore. An orifice is between the supply passage and a second chamber and a nozzle couples the second chamber to the control chamber. A servo valve has a flapper that controls flow of fluid through the nozzle. A valve spool in the bore has a first position at which the brake actuator passage is coupled to the brake passage, and a second position at which the return passage is coupled to the brake passage. The position of the valve spool is determined by pressures in the first chamber and the second chamber.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention relates to hydraulic valves for operating wheel brakes on a vehicle, such as aircraft, and more particularly to such hydraulic valves for use in anti-skid braking systems.

2. Description of the Related Art

Aircraft incorporate a hydraulic braking system which activates brakes attached to the wheels to slow or stop the aircraft while on the runway or taxiway. To activate the aircraft brakes, the pilot presses a brake pedal which is mechanically linked to a brake valve that controls the flow of hydraulic fluid from a supply line. A pump draws fluid from a reservoir, commonly called a tank, and feeds that fluid under pressure into the supply line. The action of the foot pedal opens the brake valve causing the pressurized fluid to flow through an anti-skid valve to a hydraulic cylinder that activates the wheel brakes.

One or more sensors detect when the wheels stop turning as occurs when they lock in a skid. The sensor signal indicating brake lockage is applied to an electronic controller which responds by activating the anti-skid valve to terminate the flow of pressurized fluid to the wheel brakes. Activation of the anti-skid valve releases the pressure applied to the wheel brakes, thereby allowing the wheels to turn. The wheels are allowed to turn briefly which motion is indicated by the sensor signal to the electronic controller. The electronic controller then responds by deactivating the anti-skid valve to once again apply pressurized fluid from the brake valve to the wheel brakes to slow the aircraft. The activation cycle of the anti-skid valve repeats if the brakes become locked again.

Various types of anti-skid valves have been developed. U.S. Pat. No. 4,251,115 discloses a type of valve that has a metering valve comprising a valve spool which moves within a bore to selectively connect the brake line to either the brake valve outlet or a return line to the reservoir. The valve spool normally is in a position where the brake line is connected to the outlet of the brake valve outlet. During a skid the valve spool moves to another position at which pressure in the wheel brakes is released to the return line. The position of the valve spool is controlled by pressure applied to one end by an electrically operated servo valve. The servo valve has a flapper which is activated by an electromagnetic field that alternately opens a pair of nozzles which connect the end of the valve spool to either the brake valve outlet or the return line. Operation of the servo valve modulates the pressure acting on the valve spool and thus the pressure applied to the brake cylinders. This type of valve provides separate nozzles for the return line and the supply line with the flapper moving to a first position which opens one of the nozzles and closes the other or to a second position in which the open and close nozzles are reversed. Movement of the flapper encounters resistance when the chamber within which the flapper is located is at a high system pressure as occurs when the nozzle for the brake valve is open.

### SUMMARY OF THE INVENTION

A hydraulic valve for an antiskid braking system comprises a body with a supply port, return port, and a brake port for connection to the wheel brake. The body further includes a bore, a first chamber and a control chamber, A supply passage couples the supply port to the first chamber, a return passage couples the return port to both the bore and the control chamber, a brake passage extends between the brake port and the bore, and a brake actuator passage opening into the bore to introduce pressurized fluid for activating the wheel brake.

A valve spool, with a first end and a second end, is slideably received within the bore. In a first position, the valve spool couples the brake actuator passage to the brake passage, and in a second position, the return passage is coupled to the brake passage. The position of the valve spool is determined by pressures in the first chamber and the second chamber which produce forces that respectively act on the first end and second ends of the valve spool.

An orifice provides a first fluid path between the supply passage and a second chamber located in the bore at the second end of the valve spool. A servo valve controls fluid flow between the second chamber and the control chamber. Preferably a nozzle has an inlet connected to the second chamber and an outlet that opens into the control chamber. The servo valve has a flapper which selectively engages and disengages the outlet to control flow of fluid through the nozzle.

### BRIEF DESCRIPTION OF THE DRAWINGS

FIG. 1 is a block diagram of an anti-skid hydraulic braking system which incorporates the present invention;

FIG. 2 is a cross sectional view through a novel anti-skid valve for the braking system in FIG. 1;

FIG. 3 is a cross sectional view through a second embodiment of an anti-skid valve;

FIG. 4 is a cross sectional view through a third embodiment of an anti-skid valve;

FIG. 5 is a block diagram of a “fly by wire” braking system for an aircraft; and

FIG. 6 is a cross sectional view through the anti-skid valve for the fly by wire braking system in FIG. 5.

### DETAILED DESCRIPTION OF THE INVENTION

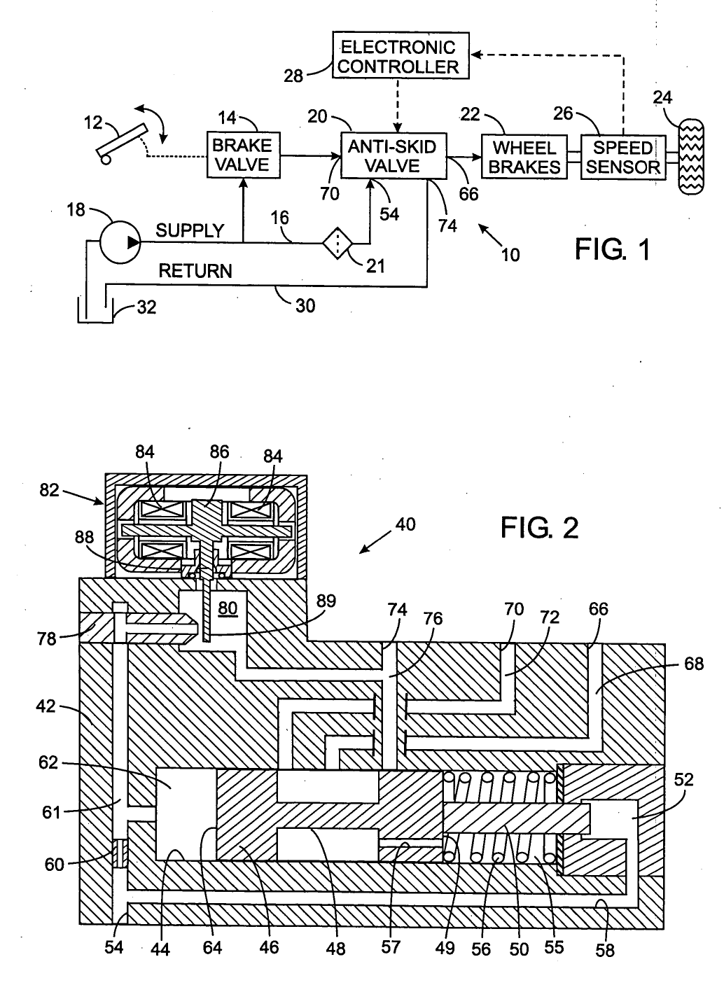

With initial reference to FIG. 1, an anti-skid braking system 10 for an aircraft or other vehicle is activated by a user depressing a foot pedal 12 mechanically coupled to a brake valve 14. Other types of user operated devices, such as a hand lever, may be used in place of the foot pedal. The brake valve 14 receives fluid from a supply line 16 which is fed from a pump or other source of pressurized fluid, such as an accumulator. When the brake valve 14 is opened by the operation of the foot pedal 12, hydraulic fluid from the supply line 16 flows to one input of an anti-skid valve 20. The anti-skid valve 20 controls the pressure applied to the brakes 22 connected to the wheels 24 of the aircraft.

One or more speed sensors 26 produce electrical signals that indicate the rotational speed of the aircraft wheels 24. These signals are applied as inputs to an electronic controller 28 of a type that is conventionally used in anti-skid braking systems.

The electronic controller 28 responds to the wheel speed signals by activating the anti-skid valve 20 when those signals indicate that a wheel has stopped turning as occurs during a skid. Activation of the anti-skid valve 20 disconnects the wheel brakes 22 from the relatively high pressure at the output of the brake valve 14 and connects the wheel brakes to a return line 30 that leads to the fluid reservoir 32 of the anti-skid braking system 10. This switching by the anti-skid valve 20 releases the relatively high pressure applied previously to the wheel brakes thereby enabling the locked wheel 24 to turn once again, which terminates the skid condition. As is standard practice for anti-skid controllers 28, once the wheels have allowed to turn a predefined amount, the anti-skid valve 20 is deactivated to apply the pressurized fluid from the brake valve 14 to the wheel brakes 22. This general operation of the anti-skid braking system 10 is well known and has generally been used on aircraft and other types of vehicles.

FIG. 2 depicts the details of a novel anti-skid valve 40 that comprises a body 42 with a plurality of passages and chambers therein. Specifically, the body 42 has a main valve bore 44 within which a valve spool 46 is slidably located. A supply port 54 is provided for connection via filter 21 to the supply line 16 of the anti-braking system 10, shown in FIG. 1. A supply passage 58 directly connects the supply port 54 to a first chamber 52 adjacent one end of the bore 44. The term “directly connects” and variations thereof refer to a connection between two or more elements without an intermediate component that restricts or controls the fluid flow between those elements other than restriction inherently provided by any conduit. A brake port 66 is provided for connection to the wheel brakes 22 and a brake passage 68 extends within the body 42 between the brake port 66 and the bore 44. The valve body 42 also has a brake valve port 70 for connection to the brake valve 14 in FIG. 1. The brake valve port 70 is coupled by a brake actuator passage 72 to the bore 44. A return port 74 is connected to a return passage 76 which also opens into the bore 44 and the valve spool 46 has a central recess 48 which selectively provides a fluid path in the bore between the brake passage 68 and one of the brake valve port 70 or the return passage 76 in different positions to the valve spool, as will be described.

A bias piston 50 engages a first end 49 of the valve spool 46 in response to pressure within the first chamber 52. A coil spring 56, located in a spring cavity 55 formed in the bore 44, tends to bias the valve spool 46 into a position wherein the central recess 48 creates a path between the brake passage 68 and the brake actuator passage 72. A bleeder passage 57 extends through the valve spool 46 from the spring cavity 55 to a cavity created by the recess 48. The bleeder passage 57 allows fluid to flow between those two cavities so that the pressure from the wheel brakes 22 is applied to the end 49 of the valve spool 46.

The supply port 54 is coupled by an orifice 60 to an intermediate passage 61 which opens into a second chamber 62 defined in the bore 44 at a second end 64 of the valve spool 46. As will be described, pressure within the second chamber 62 exerts a force on the second end 64 of the valve spool. The intermediate passage 61 also extends to the inlet of a nozzle 78 which has an outlet that opens into a control chamber 80. The return passage 76 opens directly into the control chamber 80. Alternatively, a separate passage from the intermediate passage 61 may be used to connect the second chamber 62 to the nozzle.

An unbalanced, nozzle-flapper servo valve 82 is provided to control the flow of fluid from the nozzle 78 into the control chamber 80. The servo valve 82 has a pair of electromagnetic coils 84 within which an armature 86 is located. A flapper 89 projects from the armature 86 into the control chamber 80 and is adjacent the outlet of the nozzle 78. As will be described, activation and deactivation of the electromagnetic coils 84 causes the armature to rotate about a pivot point 88 which moves the flapper against and away from the outlet at the tip of the nozzle 78. That motion opens and closes the nozzle. The nozzle tip thereby forms a valve seat which the flapper 89 engages to terminate fluid flow from the intermediate passage 61 into the control chamber 80. It should be understood that other types of electrically controlled valve mechanisms may be employed to control that flow.

Although the valve body 42 is shown as a single piece, it should be understood that it could be fabricated in two or more sections that either abut one another or are connected by hydraulic lines. Therefore, as used herein, the term “body” encompasses not only a single piece housing, but also a plurality of housings that contain the various elements of the anti-skid valve 20. It also will be apparent to one skilled in the art, that the components of the brake valve 14 and the anti-skid valve 20 can be combined into the same housing.

FIG. 2 illustrates the anti-skid valve 40 in a normal state in which the flapper 89 of the servo valve 82 is disengaged from the outlet of the nozzle 78, thereby allowing fluid to flow through the nozzle into the control chamber 80 and the return port 74. Because fluid flows from the intermediate passage 61 through the nozzle to the low pressure return port 74 and because the orifice 60 restricts flow into the intermediate passage 61 from the supply port 54, pressure in the second chamber 62 is significantly lower than the pressure in the supply passage 58. At the same time, the higher supply passage pressure is applied to the first chamber 52, adjacent the other end of the bore 44, so that the first chamber is at a greater pressure than the second chamber 62. That greater pressure in the first chamber 52 forces the bias piston 50 against the first end of the valve spool. The combined force from the bias piston 50 and the spring 56 exceeds the force exerted on the second end 64 of the valve spool 46 by the pressure in the second chamber 62. That force differential holds the valve spool 46 in a first position illustrated in FIG. 2.

With reference to FIGS. 1 and 2, the pilot depressing the foot pedal 12 opens the brake valve 14 which applies pressurized fluid through the brake valve port 70 into the brake actuator passage 72 of the anti-skid valve 40. With the valve spool 46 in the illustrated first position, the recess 48 of valve spool 46 provides a path from the brake actuator passage 72 into the brake passage 68 from which the fluid continues to flow through the brake port 66 to the wheel brakes 22. The application of this pressurized fluid causes the wheel brakes to engage and slow the aircraft wheels 24. Note that in this normal state of the anti-skid valve 40, the opening of the return passage 76 into the bore 44 is closed by a land of the valve spool 46.

If at this time the speed sensor 26 detects that the wheel brakes 22 become locked, the electronic controller 28 activates the servo valve 82. That activation drives the flapper 89 against the outlet of the nozzle 78 in FIG. 2, thereby restricting the flow of fluid through the nozzle into the control chamber 80. Alternatively, operation of the servo valve 82 could be reversed such that the flapper 89 engages the nozzle in the deactivated state. Without fluid flow through the nozzle, pressure within the second chamber 62 rises to equal the pressure at the supply port 54. Thus, the pressure within the first and second chambers 52 and 62 becomes equalized. The large surface area of the valve spool 46 in the second chamber 62 results in a greater force acting on the second end 64 than the combined force of the bias piston 50 and spring 56 acting on the valve spool's first end 49. As a consequence of this force differential, the valve spool 46 moves rightward into a second position in the orientation of the anti-skid valve 40 in FIG. 2. In this second position, the recess 48 in the valve spool 46 provides a path between the brake passage 68 and the return passage 76 which relieves the pressure previously applied to the wheel brakes 22. This releases the wheel brakes allowing the aircraft wheels 24 to turn. At this time, a land of the valve spool 46 now closes communication between the brake valve port 70 and the bore 44.

As is conventional practice, the electronic controller 28 permits a given amount of wheel motion to occur, after which the servo valve 82 is deactivated to open the outlet of the nozzle 78. This action causes pressure within the second chamber 62 to decrease which results in the valve spool 46 returning to the first position at which the wheel brakes 22 again are activated.

In order for proper anti-skid operation, the pressure at the supply port 54 must be greater than the pressure at the brake valve port 70. Otherwise the valve spool 46 will be held in the position illustrated in FIG. 2 and can not move to provide a path between the brake port 66 and the return port 74 that relieves the pressure at the wheel brakes. As long as a greater supply port can be assured this embodiment functions as described.

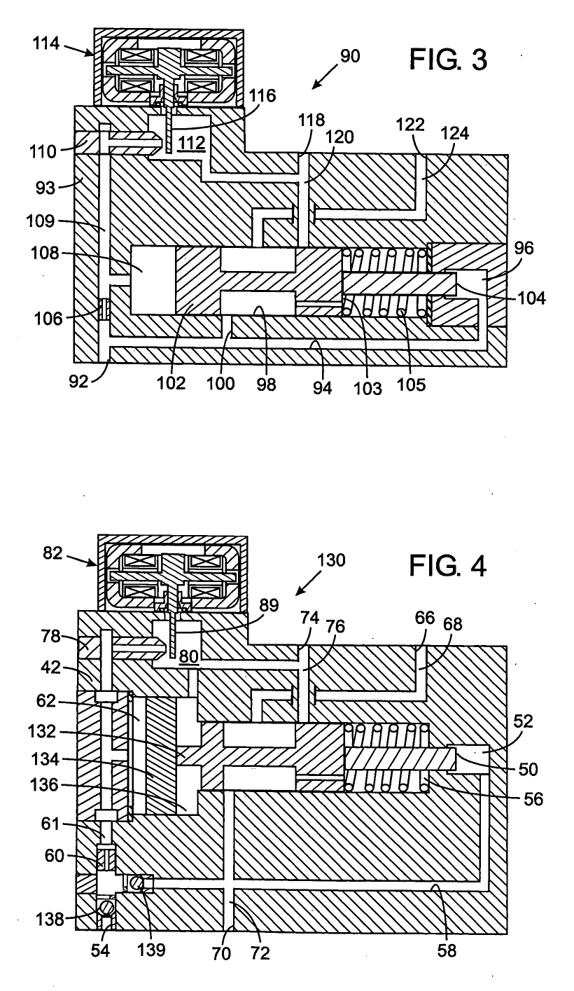

FIG. 3 depicts a second anti-skid valve 90 in which a supply port 92 is connected by a filter (not shown) to the outlet of the brake valve 14. Unlike the prior anti-skid valve 40 this version 90 does not have a port for connection to the supply line 16. The pressurized fluid from activation of the brake valve 14 provides the necessary pressure for the second anti-skid valve 90 to operate. In this regard, a supply passage 94 extends in the body 93 between the supply port 92 and a first chamber 96 adjacent one end of the bore 98. A brake actuator passage 100 directly connects the supply passage 94 to the bore 98. A valve spool 102 is slidably received in the bore 98 with a first end 103 that is engaged by a bias piston 104 and a spring 105.

An orifice 106 couples the supply port 92 to a second chamber 108 in the bore at the second end of the valve spool 102. An intermediate passage 109 is provided which conveys fluid from the second chamber 108 through a nozzle 110 into a control chamber 112. A servo valve 114 similar to the one described previously with respect to FIG. 2 has a flapper 116 within the control chamber 112 to selectively open and close the outlet of the nozzle 110. The control chamber 112 is connected to a return port 118 by a return passage 120 which also opens into the bore 98. A brake port 122, for connection to the wheel brakes 22, is connected by a brake passage 124 to the bore 98.

With this second anti-skid valve 90, when the pilot depresses the brake pedal 12, thereby opening the brake valve 14 in FIG. 1, the pressurized fluid from the brake valve is applied via the supply passage 94 to the first chamber 96. In the normal state of the anti-skid valve, the flapper 116 is disengaged from the nozzle 110 which allows fluid to flow through that nozzle. Because of this fluid flow and the orifice 106, pressure in the second chamber 108 at this time is lower than the pressure in the first chamber 96. As a result of this pressure differential, the valve spool 102 is placed into a first position illustrated in FIG. 3. In this first position, fluid is able to flow from the supply port 92 through the brake actuator passage 100 to the brake passage 124 and onward through the brake passage 124 to activate the wheel brakes 22. Note that in the first position, a land of the valve spool 102 closes the bore opening into the return passage 120.

When the electronic controller 28 detects that the signal from the speed sensor 26 indicates that a wheel 24 has locked, the controller activates the servo valve 114, driving the flapper 116 against the outlet of the nozzle 110 and terminating fluid flow through the nozzle. Thereafter pressure in the second chamber 108 increases to equal pressure in the supply passage 94 and the first chamber 96. This equalized pressure operating on the larger surface of the valve spool 102 in the second chamber 108 drives the valve spool to the right in FIG. 3 into a second position. In this second position, a land of the valve spool 102 closes the opening of the brake actuator passage 100 into the bore 98 and opens the bore to the return passage 120. This allows fluid to flow from the wheel brakes 22 through the brake passage 124 and the return passage 120 to the tank return line 30. Therefore, the relatively high pressure that previously activated the wheel brakes 22 is relieved releasing the brakes so that the aircraft wheels 24 can turn again.

After momentarily allowing the wheels of the aircraft to turn, the electronic controller 28 once again deactivates the servo valve 114 to enable fluid flow through the nozzle 110, creating a pressure differential between the two chambers 96 and 108. This results in the valve spool 102 returning to the first position at which the wheel brakes are again activated. This cycle can repeat as long as the electronic controller 28 continues to detect locking of the wheel brakes 22.

With reference to FIG. 4, a third anti-skid valve 130 is similar to that shown in FIG. 2 and identical components being assigned the same reference numerals. However, this third anti-skid valve 130 has a valve spool 132 with an end that abuts a larger diameter pressure compensation piston 134 with a cavity 136 there between. That cavity 136 is directly connected to the return passage 76. Alternatively the valve spool 132 and the pressure compensation piston 134 can be fabricated as a single piece. The second chamber 62 is on the other side of the pressure compensation piston 134. A first check valve 138 is located between the supply port 54 and the supply passage 58 and allows fluid to flow only in a direction from the supply port into that passage. A second check valve 139 has been added to allow fluid to flow only from the brake actuator passage 72 to the supply passage 58.

The third anti-skid valve 130 utilizes the greater pressure at either the supply port 54 or the brake valve port 70 to operate the valve spool 46. Because the supply port pressure acts on the larger surface area of the pressure compensation piston 134 than the surface area of the valve spool 132 to which the brake valve port pressure is applied, the third anti-skid valve 130 functions properly even when pressure at the supply port 54 is less than the brake valve output pressure. The valve spool and pressure compensation piston arrangement can be used in the first and second anti-ski valves 40 and 90 to ensure proper operation in the event that the supply port 54 is less than the brake valve port pressure. Except for this pressure compensation feature, the operation of the third anti-skid valve 130 is the same as that described previously with respect to the first anti-skid valve 40 in FIG. 2.

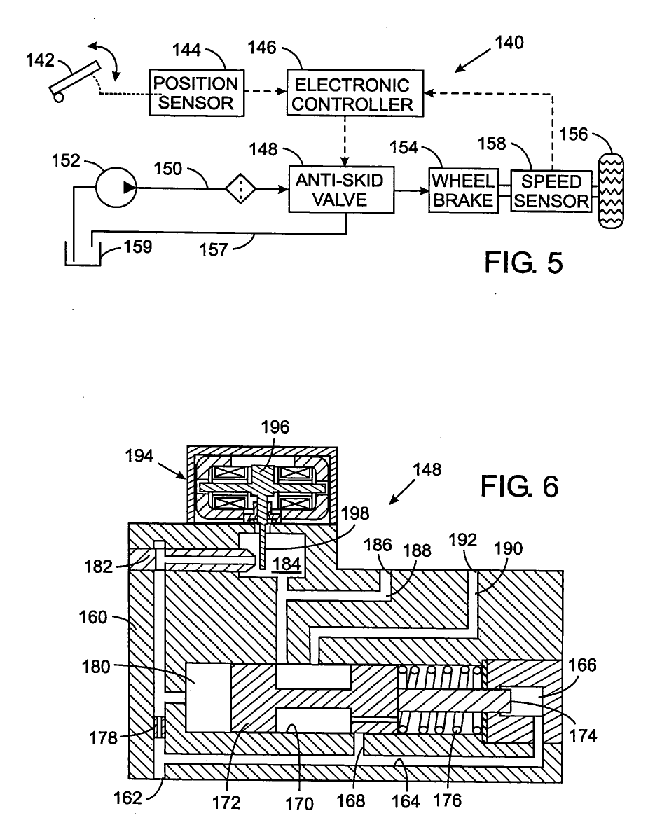

Although the aircraft industry historically has utilized hydromechanical control systems to operate various components on the aircraft, there is a present trend toward electrohydraulic systems, commonly referred to as “fly-by-wire” systems. With electrohydraulic systems, the pilot operates an input device that generates an electrical signal which is used to control motion of an associated aircraft component. FIG. 5 illustrates an example of a fly-by-wire braking system 140. With this system, depressing the brake pedal 142 operates a position sensor 144 that produces an electrical signal which is applied to an input of an electronic controller 146. This signal indicates when the pilot of the aircraft desires to activate the wheel brakes and the degree to which the brakes are to be applied. The sensor signal causes the electronic controller to operate an anti-skid valve 148 to apply pressurized fluid from the supply line 150 to the wheel brakes 154 thereby slowing the aircraft wheels 156. A conventional speed sensor 158 detects the rotational speed of the wheels 156 and provides a speed signal as in input to the electronic controller 146. A return line 157 connects the anti-skid valve 148 to the hydraulic tank 159.

The details of the anti-skid valve 148 for the fly-by-wire braking system 140 are shown in FIG. 6. This valve comprises a body 160 with a supply port 162 to which the supply line 150 from the pump 152 is connected. A supply passage 164 extends from the supply port 162 to a first chamber 166 and a brake actuator passage 168 couples the supply passage 164 to a bore 170 within the body 160. A valve spool 172 is slidably located within the bore 170 and is engaged by a bias piston 174 in response to pressure in the first chamber 166. A spring 176 biases the valve spool 172 away from the end of the bore 170 adjacent the first chamber 166.

An orifice 178 provides a path for fluid to flow between the supply port 162 and a second chamber 180 within the bore 170 at the opposite side of the valve spool 172 from the bias piston 174. The second chamber 180 is connected through a nozzle 182 to a control chamber 184 in the body 160. The control chamber 184 is coupled to a return port 186 in the body by a return passage 188 which also opens into the bore 170. A brake passage 190 extends between the bore 170 and a brake port 192 of the anti-skid valve 148.

A servo valve 194, identical to the servo valves in the other embodiments of the anti-skid valve, is connected to the body 160 and has an armature 196 from which a flapper 198 projects into the control chamber 184. In the normal state of the anti-skid valve 148, the flapper 198 is spaced from the outlet of the nozzle 182 so that fluid can flow there through.

This normal state of the anti-skid valve 148 occurs when the pilot of the aircraft does not desire to activate the wheel brakes 154. Because the nozzle opens the second chamber 180 to the low pressure return port 186, the second chamber is at a lower pressure than the first chamber 166. As a consequence, the bias piston 174 and the spring one 176 exert a greater force on the respective end of the valve spool 172 than the force exerted on the other end by pressure in the second chamber 180. This results in the valve spool 172 being in the illustrated first position at which the opening the brake actuator passage 168 into the bore 170 is blocked and a path exists between the brake passage 190 connected the wheel brakes 154 and the return passage 188 leading to the hydraulic reservoir 159. This latter path creates a relatively low pressure within the wheel brakes 154 so that the brakes disengage, allowing the aircraft wheels 156 to turn freely.

To operate the wheel brakes 154, the pilot depresses the brake pedal 142 which results in a brake activation signal being sent to the electronic controller 146. In response to this signal, the electronic controller 146 operates the servo valve 194 of the anti-skid valve 148. When activated, the servo valve 194 moves its flapper 198 against the outlet of the nozzle 182, thereby terminating the fluid flow through the nozzle. This allows the pressure within the second chamber 180 to increase until it equals the pressure in the first chamber 166 at the opposite end of the bore 170. With these pressures equalized, the large surface area of the valve spool 172 in the second chamber 180 produces a greater force acting on that end of the valve spool than the combined forces of the bias piston 174 and the spring 176 at the opposite spool end. As a result, the valve spool 172 moves toward the left in FIG. 6, closing off the opening of the return passage 188 into the bore 170 and opening communication between the brake actuator passage 168 and the bore. This applies the pressure from the supply passage 164 to the brake passage 190 and ultimately to the wheel brakes 154 thereby slowing the aircraft wheels 156.

This state of the anti-skid valve 148 continues as long as the pilot is depressing the brake pedal 142 and brake locking does not occur. When either of those conditions exists, the electronic controller 146 de-energizes the servo valve 194 allowing the flapper 198 to move away from the outlet of the nozzle 182. That action reduces the pressure within the second chamber 180 to below the pressure in the first chamber 166 which as described previously, causes the valve spool 172 to move to the position shown in FIG. 1 at which the wheel brakes 154 are connected to the tank return line 157. This connection disengages the wheel brakes.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. For example, the present anti-skid valve may be used on other types of vehicles than just aircraft. Accordingly, the scope of the invention should be determined from the following claims and not limited by the above disclosure.

1. A hydraulic valve for an antiskid braking system that controls a wheel brake of a vehicle, said hydraulic valve comprising:
a body having a supply port, return port, and a brake port for connection to the wheel brake, the body further including a bore, a first chamber and a control chamber wherein a supply passage is coupled to the supply port and the first chamber, a return passage couples the return port to the bore and the control chamber, a brake passage connects the brake port and the bore, and a brake actuator passage opens into the bore to introduce pressurized fluid for activating the wheel brake;
a valve spool, with a first end and a second end, is slideably received within the bore, the valve spool having a first position at which the brake actuator passage is in communication with the brake passage, and a second position at which the return passage is in communication with the brake passage, wherein the position of the valve spool is determined by pressures in the first chamber and the second chamber which produce forces that respectively act on the first end and second ends of the valve spool;
an orifice providing a first fluid path between the supply passage and a second chamber located in the bore at the second end of the valve spool; and
a servo valve which selectively controls fluid flow between the second chamber and the control chamber.

2. The hydraulic valve as recited in claim 1 further comprising a piston engaging the first end of the valve spool in response to pressure in the first chamber.

3. The hydraulic valve as recited in claim 1 further comprising a spring biasing the first end of the valve spool with respect to the body.

4. The hydraulic valve as recited in claim 1 further comprising a nozzle having an inlet connected to the second chamber and an outlet that opens into the control chamber; and wherein the servo valve includes a flapper which selectively engages and disengages the nozzle to control fluid flow there through.

5. The hydraulic valve as recited in claim 4 wherein the servo valve has a de-activated state in which the flapper is disengaged from the outlet of the nozzle.

6. The hydraulic valve as recited in claim 4 wherein the servo valve has a de-activated state in which the flapper engages the outlet of the nozzle.

7. The hydraulic valve as recited in claim 1 wherein the brake actuator passage is connected to a brake valve port in the body.

8. The hydraulic valve as recited in claim 7 further comprising a first check valve that permits fluid to flow from the supply port to the second chamber; and a second check valve that permits fluid flow from the brake valve port to the second chamber.

9. The hydraulic valve as recited in claim 1 wherein the brake actuator passage is connected to the supply port.

10. A hydraulic valve for an antiskid braking system that controls a wheel brake of a vehicle in response to user operation of an actuation device, said hydraulic valve comprising:
a body having a supply port, return port, a brake valve port that receives pressure from the actuation device, and a brake port for connection to the wheel brake, the body further including a bore, a first chamber and a control chamber wherein a supply passage extends between the supply port and the first chamber, a return passage couples the return port to the bore and to the control chamber, a brake actuator passage connects the brake valve port to the bore, and a brake passage couples the brake port to the bore;
a valve spool has a first end and a second end and is slideably received within the bore, the valve spool having a first position at which the brake actuator passage is coupled to the brake passage, and a second position at which the return passage is coupled to the brake passage;
a piston engaging the first end of the valve spool in response to pressure in the first chamber;
an orifice providing a first fluid path between the supply port and a second chamber located in the bore at the second end of the valve spool;
a nozzle having an inlet connected to the second chamber and having an outlet that opens into the control chamber; and
a servo valve having a flapper which selectively engages and disengages the outlet to control flow of fluid through the nozzle.

11. The hydraulic valve as recited in claim 10 further comprising a spring biasing the first end of the valve spool with respect to the body.

12. The hydraulic valve as recited in claim 10 wherein the valve spool is in the first position when force acting on the first end is greater than force acting on the second end; and is in the second position when force acting on the second end is greater than force acting on the first end.

13. The hydraulic valve as recited in claim 10 further comprising a first check valve that permits fluid to flow from the supply port to the second chamber; and a second check valve that permits fluid flow from the brake valve port to the second chamber.

14. A hydraulic valve for an antiskid braking system that controls a wheel brake of a vehicle in response to user operation of an actuation device, said hydraulic valve comprising:
a body having a supply port, return port, and a brake port for connection to the wheel brake, the body further including a bore, a first chamber and a control chamber wherein a supply passage couples the supply port to the bore and to the first chamber, a return passage couples the return port to the bore and the control chamber, and a brake passage couples the brake port to the bore;
a valve spool has a first end and a second end and is slideably received within the bore, the valve spool having a first position at which the brake actuator passage is coupled to the brake passage, and a second position at which the return passage is coupled to the brake passage;
an orifice providing a first fluid path between the supply port and a second chamber located in the bore at the second end of the valve spool;
a piston engaging the first end of the valve spool in response to pressure in the first chamber;
a nozzle having an inlet connected to the second chamber and having an outlet that opens into the control chamber; and
a servo valve having a flapper which selectively engages and disengages the outlet to control flow of fluid through the nozzle.

15. The hydraulic valve as recited in claim 14 further comprising a spring biasing the first end of the valve spool with respect to the body.

16. The hydraulic valve as recited in claim 14 wherein the valve spool is in the first position when force acting on the first end is greater than force acting on the second end; and is in the second position when force acting on the second end is greater than force acting on the first end.

17. The hydraulic valve as recited in claim 14 wherein the valve spool is in the first position when force acting on the second end is greater than force acting on the first end; and is in the second position when force acting on the first end is greater than force acting on the second end.

18. A hydraulic valve for an antiskid braking system that controls a wheel brake of a vehicle in response to user operation of an actuation device, said hydraulic valve comprising:
a body having a supply port, return port, a brake valve port that receives pressure from the actuation device, and a brake port for connection to the wheel brake, the body further including a bore, a first chamber and a control chamber, wherein a supply passage extends between the supply port and the first chamber, a return passage couples the return port to the bore and to the control chamber, a brake actuator passage couples the brake valve port to the bore, and a brake passage extends between the brake port and the bore;
a first check valve that permits fluid to flow from the supply port to the second chamber;
a second check valve that permits fluid flow from the brake valve port to the second chamber;
a valve spool has a first end and a second end and is slideably received within the bore, the valve spool having a first position at which the brake actuator passage is coupled to the brake passage, and a second position at which the return passage is coupled to the brake passage;
an orifice providing a first fluid path between the supply passage and a second chamber located in the bore at the second end of the valve spool;
a piston engaging the first end of the valve spool in response to pressure in the first chamber;
a nozzle having an inlet connected to the second chamber and having an outlet that opens into the control chamber; and
a servo valve having a flapper which selectively engages and disengages the outlet to control flow of fluid through the nozzle.

19. The hydraulic valve as recited in claim 18 further comprising a spring biasing the first end of the valve spool with respect to the body.

20. The hydraulic valve as recited in claim 18 wherein the valve spool is in the first position when force acting on the first end is greater than force acting on the second end; and is in the second position when force acting on the second end is greater than force acting on the first end.
